(19) United States
(12) Patent Application Publication
(10) Pub. No.: US 2004/0144763 A1
(43) Pub. Date: Jul. 29, 2004

(54) Arc welding method

(76) Inventors: Weihua Pan, Kunsan (CN); Xiaoping Li, Kunsan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/441,815

(22) Filed: May 19, 2003

(30) Foreign Application Priority Data
Jan. 29, 2003 (TW) 92101910

(51) Int. Cl. B23K 9/007

(52) U.S. Cl. 219/127

(57) ABSTRACT

An arc welding method for welding first and second sheet welding members (1, 2) requires a power supply (5) including two electrodes (3, 4). Welding points (13) on the first welding member are determined. An extrusion (132) is formed on the first welding member at each welding point. The extrusions contact the second welding member. The second welding member is attached to an electrode. One of the extrusions of the first welding member is connected with the other electrode. The power supply is turned on. Electric current flows from the extrusion to the second welding member, and much of air is ionized around the extrusion. Thus the extrusion is welded on the second welding member. Once all the welding points are welded on the second welding member, the first and second welding members are securely welded together.

### BACKGROUND OF THE INVENTION

1. Field of the Invention

1. The present invention relates to welding methods, and more particularly to an arc welding method for welding two pieces of metal together.

2. Description of the Prior Art

A conventional arc welding method for permanently connecting first and second sheet metal welding members requires a power supply. The power supply includes positive and negative electrodes. Positions of welding points on the first welding member are determined. The positive electrode is attached to the first welding member at one of the welding points, and the negative electrode is connected with the second welding member. The power supply is turned on. Electric current traveling from the first welding member to the second welding member mostly flows near the welding point. As a result, most heat is generated near the welding point, thereby melting the first and second welding members around the welding point.

Additionally, when the power supply is turned on, numerous electric charges are mostly distributed on contact surfaces of the first and second welding members around the welding point, thereby establishing an electric field between the contact surfaces around the welding point. Air around the welding point is ionized, and heat is generated by electrical discharge of the air. Consequently, the first and second welding members are further heated around the welding point, thereby facilitating welding of the first welding member to the second welding member. Once all of the welding points have been welded on the second welding member, the first and second welding members are securely welded together.

However, the contact surfaces of the first and second welding members are smooth and parallel to each other. The electric current traveling from the first welding member to the second welding member mostly flows via a relatively large area around the welding point. Thus the generated heat is relatively diffuse at the welding point. For similar reasons, the electric charges are also relatively diffuse around the welding point. Therefore the electric field thereat tends to be relatively weak. Ionization of the air is limited, and relatively little electrical discharge heat is generated. The first and second welding members may be only tenuously welded together at each of the welding points. In subsequent use, the first and second welding members are liable to become detached from each other.

Accordingly, there is a need to provide an improved arc welding method that overcomes the above-mentioned problems.

### SUMMARY OF THE INVENTION

Accordingly, one main object of the present invention is to provide an arc welding method that can readily and securely weld two pieces of metal together.

To fulfill the above-mentioned object, a preferred arc welding method for first and second sheet welding members is provided according to the present invention. The arc welding method requires a power supply including positive and negative electrodes. The positive electrode is connected with an electrode pole. A plurality of welding points on the first welding member is predetermined. An extrusion is formed on the first welding member at each welding point. The first welding member is attached to the second welding member at the welding points. The second welding member is attached to the negative electrode. The pole is connected with one of the extrusions. The power supply is turned on. When electric current flows from the extrusion to the second welding member, and much of air is ionized around the extrusion. Thus much heat is generated to melt the first and second welding members at the extrusion. Thus the extrusion is welded on the second welding member. Once all the welding points are welded on the second welding member, the first and second welding members are securely welded together.

In addition, a recess is defined in the first welding member around each extrusion. During welding, the recess receives molten metal of the first and second welding members, thereby enabling the first welding member to closely contact the second welding member.

Other objects, advantages and novel features of the present invention will become more apparent from the following detailed description when taken in conjunction with the accompanying drawings, in which:

### BRIEF DESCRIPTION OF THE DRAWINGS

FIG. 1 is a simplified isometric and schematic view of two welding members ready to be welded together by welding equipment according to the preferred method of the present invention;

FIG. 2 is a cross-sectional view taken along line II-II of FIG. 1; and

FIG. 3 is a flow diagram of the preferred method of the present invention.

### DESCRIPTION OF PREFERRED EMBODIMENT OF THE INVENTION

Reference will now be made to the drawings to describe the present invention in detail.

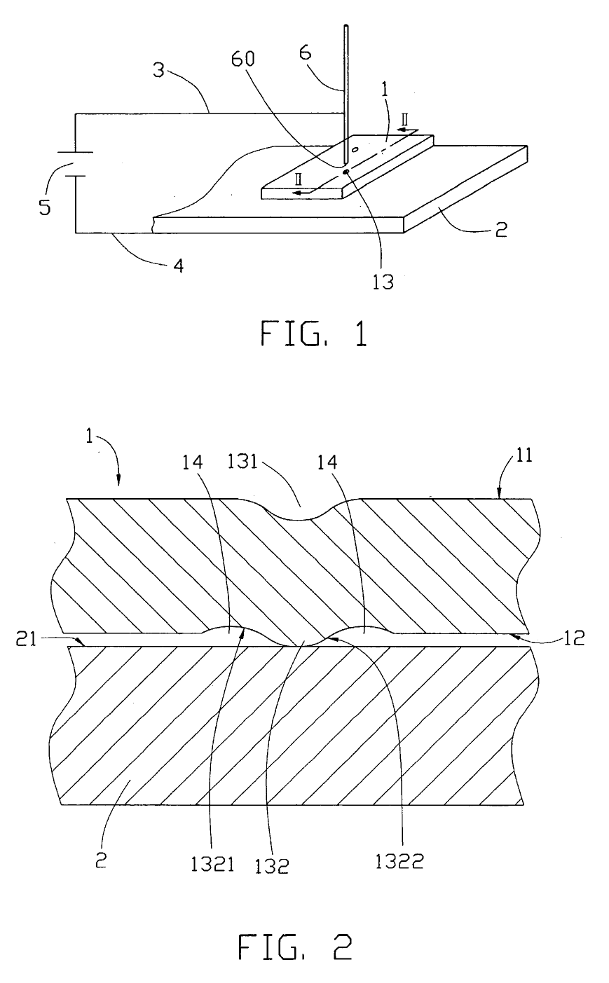

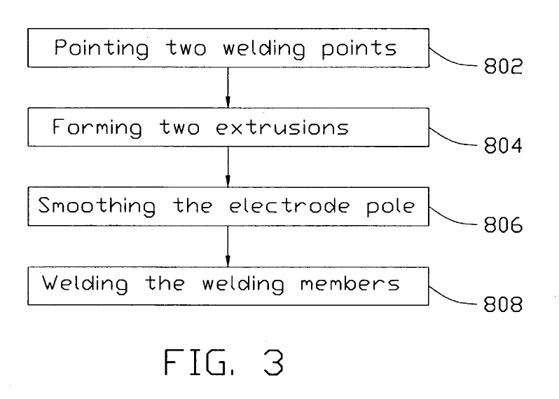

Referring to FIGS. 1 and 2, an arc welding method according to the present invention is for welding first and second plate-shaped welding members 1, 2. The first and second welding members 1, 2 are each formed from weldable material such as metal. A power supply 5 is provided for electric power. The power supply 5 includes positive and negative electrodes 3, 4. The positive electrode 3 is connected to an electrode pole 6. The first welding member 1 is formed with top and bottom surfaces 11, 12. The second welding member 2 is formed with a top surface 21. Referring also to FIG. 3, the arc welding method comprises the following steps:

Pointing step 802: two welding points 13 on the first welding member 1 are determined by conventional welding positioning tools (not shown). The welding points 13 are arranged substantially along a diagonal axis of the first welding member 1.

Forming step 804: an extrusion 132 is formed on the first welding member 1 at each welding point 13, the extrusion 132 protruding beyond a plane defined by the bottom surface 12. As a result of the forming the extrusion 132, a dimple 131 is correspondingly defined in the first welding member 1 at the welding point 13. The extrusion 132 is configured with a dome-shaped protruding surface 1322 and an annular concave surface 1321. The protruding surface 1322 smoothly merges with the concave surface 1321. A recess 14 is defined in the first welding member 1 around the extrusion 132, for receiving molten metal of the first and second welding members 1, 2.

Smoothing step 806: a bottom surface 60 of the electrode pole 6 is smoothed, for being closely received in each of the dimples 13.

Welding step 808: the first welding member 1 is attached on the second welding member 2 at the welding points 13 so that it is parallel to the second welding member 2, with the protruding surfaces 1322 of the extrusions 132 contacting the top surface 21 of the second welding member 2. The second welding member 2 is connected with the negative electrode 4 of the power supply 5. The bottom surface 60 of the electrode pole 6 is disposed in one of the dimples 131 so that it contacts an inner surface of the dimple 131. The corresponding extrusion 132 is thereby connected with the positive electrode 3 of the power supply 5. The power supply 5 is turned on. Electric current flows from the first welding member 1 to the second welding member 2 via the extrusion 132. Thus much of heat generated converges at the extrusion 132 of the first welding member 1.

Additionally, positive and negative electric charges are distributed on the bottom surface 12 of the first welding member 1 and the top surface 21 of the second welding member 2, respectively. The protruding surfaces 1322 of the extrusions 132 have the greatest curvature of the bottom surface 12. When the electric current flows from the first welding member 1 to the second welding member 2, a great amount of positive electric charges converge on the protruding surface 1322 of the corresponding extrusion 132, and a strong electric field is established between the bottom surface 12 and the top surface 21 around the corresponding welding point 13. Thus much air around the extrusion 132 is ionized, and much heat is generated by electrical discharge of the air.

In combination, the above-described heat is sufficient for the first and second welding members 1, 2 to be fully melted at the welding point 13, thereby firmly welding the welding point 13 on the second welding member 2. Once both of the welding points 13 have been welded on the second welding member 2, the first and second welding members 1, 2 are securely welded together.

Additionally, during welding, the corresponding recess 14 of the first welding member 1 receives molten metal of the first and second welding members 1, 2, thereby enabling the first welding member 1 to closely contact the second welding member 2.

In the above-described arc welding method, only two welding points 13 have been described. It should be understood that there may alternatively be only one welding point 13, or there may alternatively be three or more welding points 13. The number of welding points 13 that is adopted depends on the particular configurations and sizes of the first and second welding members 1, 2, and on the particular application intended for the combined first and second welding members 1, 2. Furthermore, it should be understood that the power supply 5 may alternatively be equipped with a plurality of electrode poles 6. All the electrode poles 6 can be connected with the positive electrode 3, and can be simultaneously disposed in a corresponding number of dimples 131 of the first welding member 1.

Moreover, although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An arc welding method for first and second welding members by a power supply including two electrodes, comprising the steps of:
providing at least one welding point on the first welding member;
at the at least one welding point of the first welding member forming extrusions; and
contacting the extrusions with the second welding member, with the second welding member being attached to an electrode of the power supply, at least one of the extrusions being attached to the other electrode of the power supply and the power supply being turned on to thereby generate heat for melting the first and second welding members at the at least one of the extrusions so as to weld the first and second welding member together.

2. The arc welding method of claim 1, wherein the first welding member forms top and bottom surfaces thereon.

3. The arc welding method of claim 2, wherein each of the extrusions protrudes beyond the bottom surface of the first welding member.

4. The arc welding method of claim 3, wherein the top surface of the first welding member is formed with a dimple at one of the welding points.

5. The arc welding method of claim 4, wherein each of the extrusions is configured with a dome-shaped protruding surface and an annular concave surface.

6. The arc welding method of claim 5, wherein the bottom surface of the first welding member is formed with a recess around one of the extrusions.

7. The arc welding method of claim 6, wherein the power supply further includes a pole, the pole defining a bottom surface.

8. The arc welding method of claim 7, further comprising the step of smoothing the bottom surface of the pole prior to contacting the extrusions with the second welding member, the bottom surface being received in one of the dimples of the first welding member.

9. The arc welding method of claim 8, wherein the first and second welding members are situated substantially parallel to each other during welding.

10. An arc welding method applied to two welding members, comprising steps of:
providing first and second planar welding members;
selecting at least one position on each of said first and second welding members to be a welding point area; wherein
at least one of said welding point areas of said first and second welding members is structurally deformed to result in more air ionized around said at least one of said welding point areas during arc welding, in comparison with a non-deformation type.

11. The method of claim 10, wherein said deformed welding point area formed on one of said first and second welding members is essentially a protrusion directing toward the other.

12. A welding arrangement comprising:
a planar first welding member;
a second planar welding member facing to said first welding member in a parallel relation; and
at least one of said first and second welding members forming a protrusion directing toward the other where a welding point is located; wherein
more air is ionized around said protrusion during an arc welding process.
